(19) United States
(12) Patent Application Publication
(10) Pub. No.: US 2009/0216519 A1
(43) Pub. Date: Aug. 27, 2009

(54) Data Processing System And Method

(76) Inventors: Mohan PARTHASARATHY, Bangalore (IN); Kishore Kumar Muppirala, Bangalore (IN); Harish Kuttan, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/392,126

(22) Filed: Feb. 25, 2009

(30) Foreign Application Priority Data
Feb. 25, 2008 (IN) 466/CHE/2008

(51) Int. Cl. G06F 9/455

(52) U.S. Cl. 703/24

(57) ABSTRACT

Embodiments of the invention relate to a data processing system and method for supporting dynamically assigning devices within a virtualisation environment.

### RELATED APPLICATIONS

Benefit is claimed under 35 U.S.C. 119(a)-(d) to Foreign application Serial No. 466/CHE/2008 entitled “DATA PROCESSING SYSTEM AND METHOD” by Hewlett-Packard Development Company, L.P., filed on 25 Feb. 2008, which is herein incorporated in its entirety by reference for all purposes.

### BACKGROUND OF THE INVENTION

Virtualization allows multiple instances of one or more operating systems to run on a shared hardware platform. Each operating system interfaces with the hardware platform in the conventional manner, that is, from the perspective of the operating system as if the whole of the resources of the hardware platform was available exclusively to any given operating system. A virtual machine monitor (VMM) is used to realize virtualization. The VMM is typically, but not exclusively, implemented in software such that each operating system is presented with a virtual machine (VM) having virtual resources that the operating system can control and use. The virtual resources can comprise, for example, one or more than one processor, memory, or any other virtualisation of resources of the platform residing at or below the VM and/or the VMM. An operating system itself and any other software that operates above a virtual machine are known as guests. The role of the VMM comprises orchestrating access to the physical, that is, non-virtualised, resources of the platform by guests.

A practical instance of such virtualisation can be found, for example, in HP's Integrity Virtual Machine technology (HPVM). HPVM is a soft partitioning and virtualization technology within HP's Virtual Server Environment that enables multiple virtual servers or machines within a single HP Integrity server or nPartition to be realised. HPVM creates a software-controlled Itanium-based virtual computer, complete with virtual CPUs, virtual memory and virtual I/O devices. Virtualisation using HPVM supports running multiple operating systems substantially concurrently on the same physical machine, that is, using the same shared hardware platform. For example, multiple instances of HP-UX, Windows, Linux or any other operating system can be executed concurrently on the same machine using virtualisation. Furthermore, all virtualised resources, including CPUs and I/O devices, can be shared between these virtual computers. HPVM provides a very flexible partitioning solution that allows users to improve system hardware use. Advantages of HPVM include, for example, software fault and security isolation and shared processor.

HPVM comprises a hypervisor, as is typical in virtualisation environments. The hypervisor of HPVM presents virtualized hardware to the one or more guest operating systems executing under its control. Parallel SCSI and Gigabit Ethernet are the typical virtual PCI adapters that are presented to the guest instances. HPVM requires a guest reboot to effect a virtual hardware change. This is especially so in the context of virtual IO interfaces such as, for example, parallel SCSI and Gigabit Ethernet.

A hypervisor runs within a host operating system (for example, HPVM's pMAN layer executing on an HP-UX operating system) and has the capability of varying, that is, expanding/shrinking, at least one of its IO capability and IO capacity, as it owns the “real” hardware, and this “real” hardware can be hot-plugged in and out. Guest operating systems (OSes) may want to vary their IO requirements depending on IO variation in the hypervisor. When resources in the hypervisor shrink, adjusting the capacity percentage allocations on a per-guest basis in the hypervisor is an option. However, resource shrinkage in the hypervisor may not be intuitively apparent to the guest operating system as a resource impact. Therefore, the guest operating system may not be able to adjust or adapt itself to the changing hypervisor capacities. Similarly, when additional resources or capacity is available to the hypervisor, the guest may not be able to exploit the additional IO capacity as it does not see the additional hardware. Most guest OSes, since they are designed and developed to work with real hardware, may only be able to deal with additional resource availability (or lack of it) only when they see additional hardware resources (or removal of the same).

A hypervisor allows physical IO devices to be shared among multiple guest operating systems. Each guest sees a virtual IO device that is emulated by the host. A hypervisor does not allow IO to be added dynamically to a guest. Furthermore, adding IO devices requires a reboot of the guest operating system.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows a data processing system according to an embodiment;

FIG. 2 depicts a data processing system according to an embodiment;

FIG. 3 illustrates a flowchart for resource allocation according to an embodiment; and

FIG. 4 shows a flowchart for resource deallocation according to an embodiment.

### DETAILED DESCRIPTION OF EMBODIMENTS OF THE INVENTION

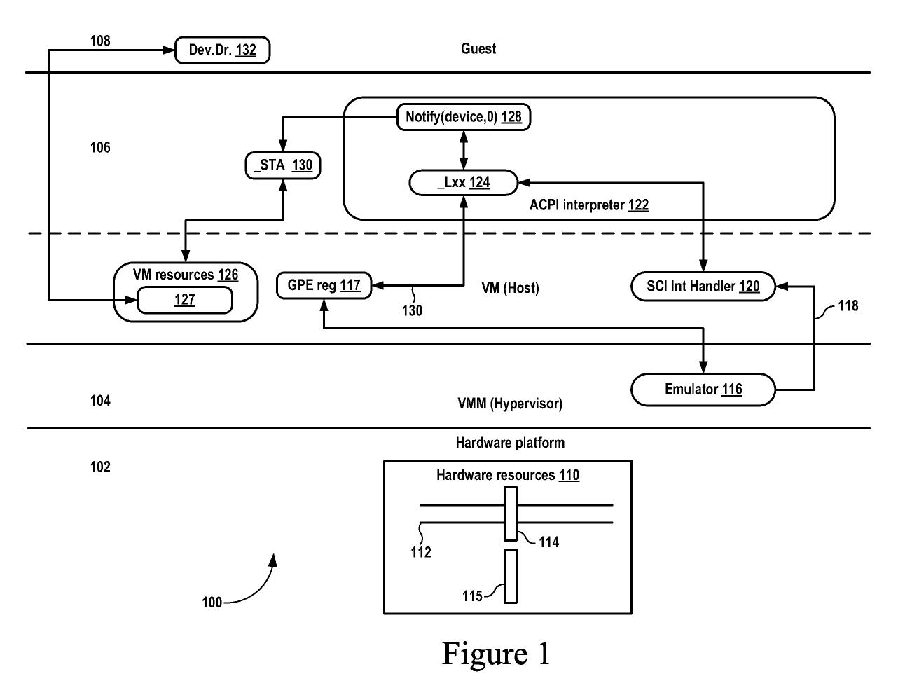

Referring to FIG. 1 there is shown a data processing system 100 according to an embodiment. The system 100 comprises a hardware platform 102, a virtual machine monitor (VMM) 104, a virtual machine or host 106 and a guest 108. The guest can be, for example, a guest operating system. In the illustrated embodiment, the guest 108 is an ACPI compliant operating system. The current version of the Advanced Configuration and Power Interface (ACPI) specification is revision 3.0b, published Oct. 10, 2006, which is incorporated herein by reference for all purposes.

The hardware platform 102 comprises hardware resources 110. In the illustrated embodiments, the hardware resources 110 comprise a PCI bus 112 having a PCI slot 114 for receiving a PCI adaptor card 115.

The VMM 104 comprises an emulator 116 arranged to emulate the operation of at least one of ACPI compliant and PCI specification compliant hardware. The emulator 116 comprises code for emulating asserting a general purpose event (GPE) using one or more than one general purpose event register 117 and raising an interrupt 118, which are typically associated with an attention button, doorbell or closing a manual retention latch (not shown) such as described in one of the PCI specifications available from, for example, http://www.pcisig.com/specifications/pciexpresss/specifications/, which specifications are incorporated herein by reference for all purposes. The interrupt 118 emulates a hardware trigger known as an SCI interrupt.

The interrupt 118 is handled within the guest 108 via a respective interrupt handler 120. The interrupt handler 120 forms part of an ACPI interpreter 122 of the guest 108. The interpreter 122 determines and closes the GPE and then runs an instance of a _Lxx method 124 associated with the GPE. An _Lxx method is described by the ACPI specification as a control method. Examples of _Lxx methods are well known to those skilled in the art of, for example, ACPI and will not be described in detail other than to the extent necessary.

The host 106 is responsible for presenting virtual resources 126 to the guest such that the guest appears to have exclusive access to all of the hardware resources 110 of the hardware platform 102. In association with the emulator 116 asserting the GPE in the GPE register 117 and generating the interrupt 118, the host 106 also creates an additional virtual resource 127 associated with the GPE. The host 106 and the VMM 104 cooperate to make a physical hardware resource associated with the GPE, such as, for example, a PCI adaptor 115 newly plugged into the slot 114 or an existing PCI adaptor card, available to the host 106 so as to form part of the virtual resources 126 of the VM 106 for use by the guest 108. In the illustrated embodiment, the GPE has a value corresponding to the event to be emulated. Therefore, the GPE can, for example, take a value that is representative of an insertion of the PCI adaptor card 115 into the slot 114.

One skilled in the art understands that an operating system, such as the guest 108, comprises a device tree. The device tree contains information about the devices attached to the system. The operating system uses information from drivers and other components to build this tree when the computer starts, and it updates the tree as devices are added or removed. The device tree is hierarchical. Devices on a bus represented are as subcomponents of the bus adapter or controller.

The instance of the _Lxx method 124 determines the type of event from the GPE. The value in the GPE register has bits corresponding to a hotplug insertion or removal action on each of the physical PCI slots on the system. In the present case, it will be appreciated that the instance 124 of the _Lxx method determines that the event was an insertion event and determines the slot into which the insertion took place. The emulator 116 emulates the operation of the _Lxx object 124. The _Lxx object 124 executes a Notify function 128, that is, Notify (device, 0), as is well known within the art, to indicate to the guest 108 that reenumeration of the device tree starting from the notified device is required. The Notify code 0 signifies that the insertion is complete, the card has been inserted into the slot, firmware has initialized the slot, and now it is up to the operating system to initialize the card and attach the appropriate device drivers. The device object can be, for example, the PCI slot object, the PCI-e root bridge or any device object which uniquely identifies the slot on which the device is situated. Enumeration of the device tree is well understood by those skilled in the art and will not be described in detail.

The guest operating system 108 handles the notification and executes an instance 130 of _STA methods for the device specified via Notify (device, 0) to determine its status. The _STA objects or methods are emulated by the emulator 116. The operation of _STA methods as well understood by those skilled in the art from the ACPI specification for _STA status methods of a device. The _STA (status) object 130 returns the status of a device, which can be one of the following: enabled, disabled, or removed. In this respect, in the result code or returned code, bit 0 is set if the device is present; bit 1 is set if the device is enabled and decoding its resources; bit 2 is set if the device should be shown in the UI and bit 3 is set if the device is functioning properly or cleared if the device failed its diagnostics.

Assuming the status object 130 returns a code with the at least bits 0, 1 and 3 set, the guest 108 scans the bus 112 and reads to the device's configuration space to identify the device, that is, the PCI adaptor card 115. The guest 108 loads and starts a device driver 132 for the device 115 and, optionally, enables the device according to the PCI power management specification.

At this point, the device driver 132 can begin using the device 127, that is, the newly assigned virtual resources, in the conventional manner.

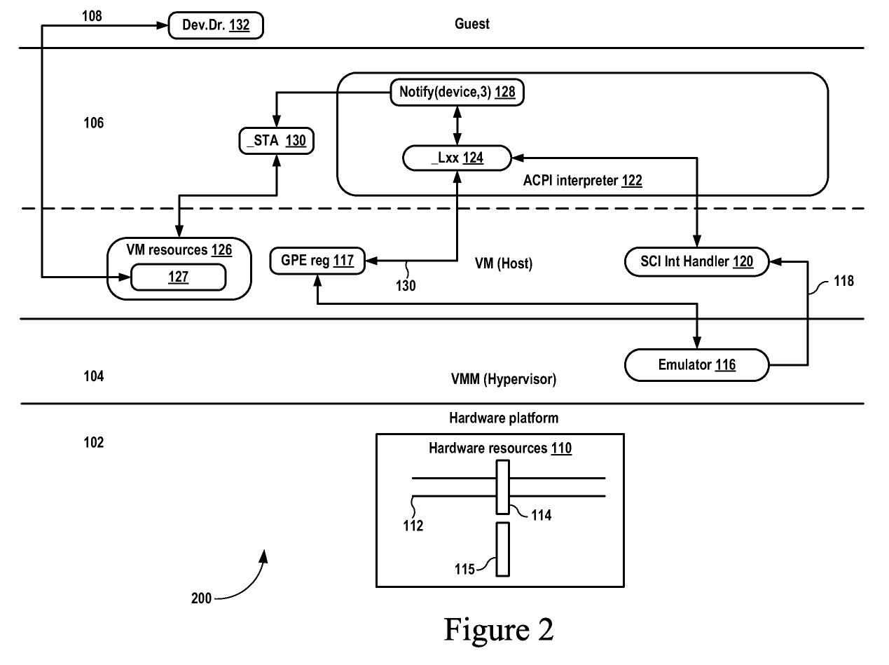

Removal of virtual resources from a VM will be described with reference to FIG. 2, in which like reference numerals relate to corresponding features of FIG. 1.

Again, the VMM 104 comprises an emulator 116 arranged to emulate the operation of at least one of ACPI compliant and PCI specification compliant hardware. The emulator 116 comprises code for emulating asserting a general purpose event (GPE) using one or more than one general purpose event register 117 and raising an interrupt 118. The interrupt 118 emulates a hardware trigger known as an SCI interrupt.

The interrupt 118 is handled within the host 106 via a respective interrupt handler 120. The interrupt handler 120 forms part of the VM, but could alternatively form part of an ACPI interpreter 122 of the guest 108. The interpreter 122 determines and closes the GPE and then runs an instance of a _Lxx object 124 associated with the GPE. Examples of _Lxx methods are well known to those skilled in the art of, for example, Unix or Linux and will not be described in detail other than to the extent necessary. The emulator 116 emulates the operation of the _Lxx object 124.

In the illustrated embodiment, the GPE has a value corresponding to the event to be emulated. Therefore, the GPE can, for example, take a value that is representative of an ejection of the PCI adaptor card 115 into the slot 114.

The instance of the _Lxx method 124 determines the type of event from the GPE. In the present case, it will be appreciated that the _Lxx object 124 method determines that the event was an ejection event and determines the slot in relation to which the GPE was asserted. The _Lxx object 124 invokes a Notify function 128, that is, Notify (device, 3) to notify the guest 108 of the ejection.

The guest operating system 108 handles the notification and instantiates an instance of an _STA object for the device object specified via Notify (device, 3) to determine its status. The _STA objects or methods are emulated by the emulator 116. The _STA (status) object 130 returns the status of a device, which can be one of the following: enabled, disabled, or removed.

If the status indicates that the device is in use, the ejection request is rejected. However, if the status indicates that the device is not in use, the guest 108 requests the device driver 132 to quiesce the card and to perform an unload operation.

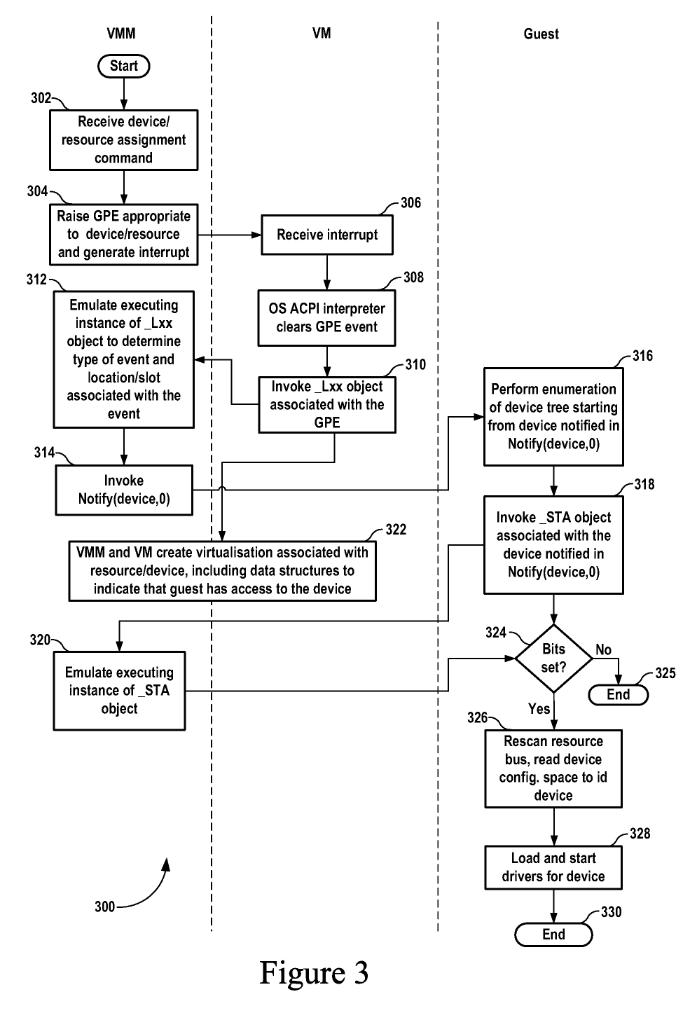

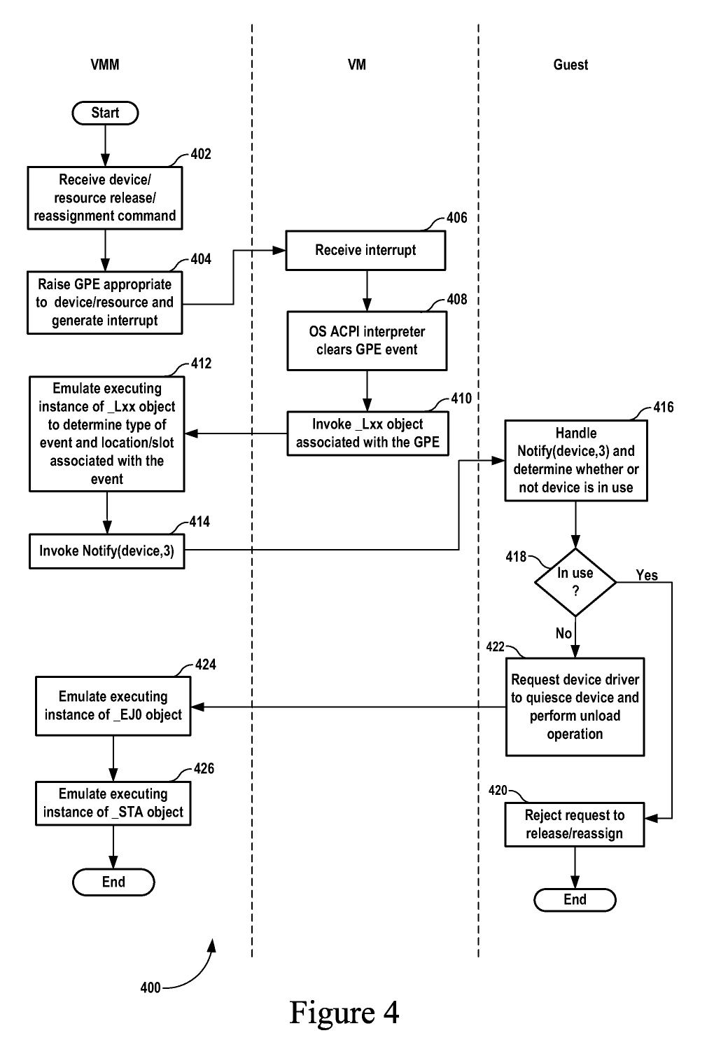

The guest 108 then performs the step of turning off the device in accordance with the PCI specification. The emulator 116 emulates an eject (_EJ0) method to eject the device and status bits are updated to reflect the status of the ejection. Finally, the guest 108 invokes an instance of the _STA object 130 to verify that the device has been ejected. The emulator 116 emulates the _STA object 130. Advantageously, embodiments of the present invention support dynamic resource assignment or reassignment in the form of, for example, virtual IO cards/slots to the guest OSes within a virtualised environment. Referring to FIG. 3, there is shown a flow chart 300 for device or resource assignment according to an embodiment. At step 302, a user or administrator of the hypervisor 104 or host 106 issues a command to assign a device or resource to a guest 108 or a virtual machine 106. The hypervisor 104, at step 304, raises a general-purpose event appropriate to the device or resource to be assigned and also raises an interrupt with the guest 106. The guest processes the interrupt at step 306. The operating system or guest ACPI interpreter 118 clears the general-purpose event at step 308 and invokes, at step 310 an _Lxx object 124 associated with the general-purpose event. The hypervisor 104 emulates the operation of the _Lxx object 124 to determine the type of the general-purpose event as well as the location or slot associated with the event at step 312. The hypervisor 104, at step 314, performs a Notify(device, 0) operation. The guest or operating system 108, in response to the Notify operation, performs enumeration of the device tree starting from the device notified in the Notify operation at step 316. The guest or operating system 108, at step 318 invokes an_STA object 130 associated with the device notified in the Notify operation. Again, the hypervisor 104 emulates the operation of the _STA object 130 at step 320 and returns a code representing the result of the status determination to the guest or operating system 108. Substantially concurrently, the hypervisor 104 and the host 106 create virtual instances associated with the resource or device to be made available to the guest 108 as part of the virtual machine 106, including data structures to indicate that the guest 108 has been granted access to the device or resource, at step 322. In response to receiving the return code containing an indication of the status of the notified device, the guest or operating system 108 determines, at step 324 whether or not a certain pattern of bits is set. If such a certain pattern of bits is not set, indicating, for example, that the device is not in a useable state, the guest or operating system 108 aborts the device addition, and the method ends at step 325. If the bits indicate that the device is in a useable state, the guest or operating system 108, at step 326, rescans the resource bus associated with the device or resource and reads the configurations space associated with the device to identify the assigned device. A driver for the device are loaded and started, at step 328, whereupon the device can be accessed in the conventional manner. The method 300 then ends at step 330. Referring to FIG. 4, there is shown a flow chart 400 for device or resource reassignment or deallocation according to an embodiment. At step 402, a user or administrator of the hypervisor 104 or host 106 issues a command to reassign or deallocate a device or resource to a guest 108 or a virtual machine 106. The hypervisor 104, at step 404, raises a general-purpose event appropriate to the device or resource to be reassigned or deallocated and also raises an interrupt with the host 106. The host processes the interrupted at step 406. The operating system or guest ACPI interpreter 118 clears the general-purpose event at step 408 and invokes, at step 410 an _Lxx object 124 associated with the general-purpose event. The hypervisor 104 emulates the operation of the _Lxx object 124 to determine the type of the general-purpose event as well as the location or slot associated with the event at step 412. The hypervisor 104, at step 414, performs a Notify(device, 3) operation. The guest or operating system 108, in response to the Notify operation, determines whether or not the device is in use at steps 416 and 418. If it is determined, at step 418, that the device is in use, the request to reassign or release the resource is rejected at step 420 and the method 400 ends at step 421. If the device is not in use, the guest request the device driver to quiesce the device and perform an unload operation at step 422. The guest or operating system invokes an instance of an _EJ0 object to eject the device. The VMM 104 emulates the operation of the _EJ0 object at step 424. Furthermore, the VMM 104 emulates the operation of the _STA object to confirm to the guest or operating system that device's status in step 426. The method then ends at step 428.

Although the embodiment described above uses a PCI bus, embodiments are not limited to such a bus. Embodiments can be realised in which other data/signal carrying arrangements are used instead such as, for example, PCI-X and PCI-e. Furthermore, the above embodiment is arranged to support assigning a PCI card to a guest. However, embodiments are not limited to such an arrangement. Embodiments can be realised in which some other form of hardware resource is assigned, or otherwise made available, to a guest. For example, the other hardware resource may comprise a data processor (e.g. CPU) or memory hardware resource.

The above embodiment has been described with reference to a single VM. However, embodiments can be realised in which the VMM 104 hosts a number of virtual machines. Furthermore, the VM 106 can host one or more than one guest. Indeed, a VM can take the form of a VMM and itself host one or more than one VM with a respective guest or more than one guest.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method to dynamically associate or disassociate a resource with a guest of a host within a virtualisation environment; the method comprising generating a trigger emulating a hardware event associated varying hardware resource capabilities of a platform supporting the virtualisation environment; establishing within the host a virtualisation of the resource; emulating within the virtualisation environment at least one response to an action performed by the guest associated with making the virtualisation of the resource available to the guest.

2. A method as claimed in claim 1, wherein generating a trigger comprises asserting a general purpose event (GPE) using one or more general purpose event registers.

3. A method as claimed in claim 1, wherein generating a trigger comprises raising an interrupt.

4. A method as claimed in claim 1, wherein emulating at least one response comprises emulating an instance of a status (_STA) object to determine a status of the resource.

5. A method as claimed in claim 1, wherein emulating at least one response comprises emulating an instance of an eject (_EJ0) method to eject the resource.

6. A method as claimed in claim 5, wherein the method comprises disassociating the resource from the guest.

7. A method as claimed in claim 1, wherein the method comprises associating the resource with the guest.

8. A method as claimed in claim 1, wherein the resource comprises at least one of a data processor, memory and PCI resource.

9. A data processing system arranged to dynamically associate or disassociate a resource with a guest of a host within a virtualisation environment; the system arranged to generate a trigger emulating a hardware event associated varying hardware resource capabilities of a platform supporting the virtualisation environment; establish within the host a virtualisation of the resource; emulate within the virtualisation environment at least one response to an action performed by the guest associated with making the virtualisation of the resource available to the guest.

10. A system as claimed in claim 9, wherein generating a trigger comprises asserting a general purpose event (GPE) using one or more general purpose event registers.

11. A system as claimed in claim 9, wherein generating a trigger comprises raising an interrupt.

12. A system as claimed in claim 9, wherein emulating at least one response comprises emulating an instance of a status (_STA) object to determine a status of the resource.

13. A system as claimed in claim 9, wherein emulating at least one response comprises emulating an instance of an eject (_EJ0) method to eject the resource.

14. A system as claimed in claim 13, wherein the method comprises disassociating the resource from the guest.

15. A system as claimed in claim 9, wherein the method comprises associating the resource with the guest.

16. A system as claimed in claim 9, wherein the resource comprises at least one of a data processor, memory and PCI resource.

17. A computer program product for dynamically associate or disassociate a resource with a guest of a host within a virtualisation environment comprising a computer readable medium the computer program product comprising a storage medium readable by a processing circuit and storing instruction for execution by a processing circuit for performing a method comprising the step of:
generating a trigger emulating a hardware event associated varying hardware resource capabilities of a platform supporting the virtualisation environment;
establishing within the host a virtualisation of the resource; and
emulating within the virtualisation environment at least one response to an action performed by the guest associated with making the virtualisation of the resource available to the guest.

18. The computer program product of claim 17, wherein generating a trigger comprises asserting a general purpose event (GPE) using one or more general purpose event registers.

19. The computer program product of claim 17, wherein emulating at least one response comprises emulating an instance of a status (_STA) object to determine a status of the resource.

20. The computer program product of claim 17, wherein emulating at least one response comprises emulating an instance of an eject (_EJ0) method to eject the resource.
